(19) United States
(12) Patent Application Publication
(10) Pub. No.: US 2007/0030994 A1
(43) Pub. Date: Feb. 8, 2007

(54) Speaker apparatus, method of manufacturing the same, and frame for the same

(75) Inventors: Tomiaki Ando, Yamagata (JP); Yohji Ogata, Yamagata (JP); Kian Ohta, Yamagata (JP); Koji Matsumoto, Yamagata (JP)

Correspondence Address: DRINKER BIDDLE & REATH (DC), 1500 K STREET, N.W., SUITE 1100, WASHINGTON, DC, 20005-1209, US

(73) Assignee: PIONEER CORPORATION & TOHOKU PIONEER CORPORATION

(21) Appl. No.: 11/497,522

(22) Filed: Aug. 2, 2006

(30) Foreign Application Priority Data
Aug. 3, 2005 (JP) P2005-225463

(51) Int. Cl. H04R 1/00

(52) U.S. Cl. 381/409

(57) ABSTRACT

According to an embodiment of the invention, a speaker apparatus comprises: a frame having a flange portion on a front surface thereof and a recessed portion on a back face thereof; a terminal lug attached to the flange portion of the frame; a capacitor accommodated in the recessed portion of the frame. The capacitor has a capacitor lead wire connected to the terminal lug at the front surface of the frame. A voice coil is connected to the terminal lug at the front surface of the frame.

### BACKGROUND

1. Technical Field

The present invention relates to a speaker apparatus, a method of manufacturing the speaker apparatus and a frame for the speaker apparatus.

2. Description of Related Art

In a small-sized speaker apparatus to be used in an acoustic apparatus for a car, it is a structure in which a capacitor is attached to a frame formed by a resin which constitutes an outer shell of the speaker apparatus, and a capacitor lead wire is connected to a terminal lug of the frame by soldering. In many cases, the capacitor of this type cannot be attached to a front surface side of the frame in respect of a space, and is disposed on a back face or a side portion of the frame.

JP-A-6-245294 has disclosed an example in which the capacitor is provided in a back part of the frame for the speaker apparatus. There has been described a structure in which a U-shaped housing portion is provided on an external wall of a connector terminal portion at the back part of the frame and a protruding dividing plate is provided in a bottom part thereof, a capacitor for reducing a noise is inserted and fixed into the U-shaped housing portion, one of lead wires of the capacitor is connected to the frame along a groove formed in the bottom part of the housing portion and the other lead wire is connected to a terminal of the connector terminal portion, thereby preventing the capacitor from slipping off due to surrounding vibration.

An attachment of network components, such as a capacitor, is formed integrally with a metal frame or a resin frame of a speaker apparatus, or the attachment is molded integrally with the metal frame. The reference “JP-A-2000-152395” discloses such an attachment structure that the capacitor is fitted into the attachment.

In addition, there has been known a connecting structure of a lead wire of a speaker and a terminal lug described in JP-A-6-70395. In the connecting structure, a lead wire is previously cut into a predetermined length set in a design. One end of the lead wire as an engaging portion formed by soldering, and the other end of the lead wire is connected to a vibrating system. The lead wire is pulled toward the vibrating system side after the lead wire passes through a notched hole of the terminal lug and a clearance between a protrusion of the terminal lug and the terminal lug. In this state, a portion of the lead wire where the lead wire is passed through the notched hole is soldered on the terminal lug.

### SUMMARY OF INVENTION

In a small-sized speaker apparatus, it is hard to provide a capacitor on a front side of the apparatus in respect of a space. The capacitor is to be disposed on a back side of a frame of the apparatus. A lead wire of the capacitor is usually connected to a terminal portion provided on the frame at the back side of the frame by soldering.

Moreover, a voice coil lead wire pulled out of a voice coil is extended toward a front side of the apparatus and is thus connected to the terminal portion of the frame by soldering. Accordingly, a terminal connection of the capacitor lead wire and that of the voice coil lead wire are subjected to a soldering processing on the back and front sides of the apparatus, respectively. Consequently, a processing at another step is forcibly carried out.

The capacitor to be attached to the speaker described in JP-A-6-245294 is connected between a voice signal terminal and a frame (ground) and is used for reducing a noise. According to an attachment of the capacitor disclosed in JP-A-6-245294, the capacitor is attached by additional process without changing a conventional process for producing a speaker, and components for attaching the capacitor is reduced. Therefore, An effective structure is not disclosed in JP-A-6-245294 in order to make a work for fixing the capacitor easy and reliable. Also, the effective structure is not disclosed in JP-A-6-245294 in order to make a connection of a capacitor lead terminal reliable.

According to an attachment of the network component disclosed in JP-A-2000-152395, a capacitor is inserted into a cylindrical holding piece having a side portion opened. Therefore, the work for attaching the capacitor is easy to perform. However, the capacitor is held by only an elastic force of the holding piece. For this reason, there is a possibility that the capacitor might slip off due to vibration.

The present invention has been made in view of the following circumstances. A capacitor is not fixed securely, and the capacitor slips off if the easiness of a work for attaching the capacitor is to be maintained. Also, a work for connecting a capacitor lead wire to a terminal portion and a work for connecting a voice coil lead wire are carried out on both back and front sides of the apparatus in the case in which the capacitor is provided on the back side of the frame. These works lead to an increase of producing processes so that a manufacturing cost is increase. Also, it is hard to set a plurality of terminal lugs one by one into a mold when the terminal lugs are to be fixed to the frame by insert molding and a workability of a subsequent processing is poor, resulting in a rise in a processing cost.

According an aspect of the invention, a speaker apparatus comprises a frame; a terminal lug attached to a flange portion provided on a front surface of the frame; and a capacitor accommodated in a capacitor housing recessed portion provided on a back face of the frame. A voice coil lead wire and a capacitor lead wire of the capacitor are connected to the terminal lug at the front surface of the frame.

According to another aspect of the invention, there is provided a method of manufacturing a speaker apparatus comprising; fixing a terminal lug to be exposed to a flange portion provided on a front surface of a frame, causing a capacitor lead wire of a capacitor accommodated in a back portion of the frame to penetrate through the terminal lug and protruding the capacitor lead wire toward a front surface of the frame, and connecting the capacitor lead wire to a voice coil lead wire via the terminal lug at the front surface of the frame.

According to still another aspect of the invention, there is provide a speaker apparatus in which a flange portion is formed in connection to a front surface, a capacitor housing recessed portion is formed in a back portion, a terminal lug is fixed to a front surface of the flange portion, and an insertion hole for a capacitor lead wire is formed in the flange portion to penetrate through the terminal lug.

### BRIEF DESCRIPTION OF THE DRAWINGS

FIG. 1 is an exemplary plan view showing a speaker apparatus according to a first embodiment of the invention as seen from a front surface thereof;

FIG. 2 is an exemplary plan view showing the speaker apparatus illustrated in FIG. 1 as seen from a back side thereof;

FIG. 3 is an exemplary partial enlarged perspective view showing a guide portion and a T-shaped position regulating portion in a capacitor lead wire in the speaker apparatus illustrated in FIG. 1;

FIG. 4 is an exemplary partial enlarged perspective view showing the capacitor lead wire and an insertion hole for the capacitor lead wire of a frame in the speaker apparatus illustrated in FIG. 1;

FIG. 5 is an exemplary schematic perspective view showing a speaker apparatus according to a second embodiment of the invention;

FIG. 6 is an exemplary schematic perspective view showing a speaker apparatus according to a third embodiment of the invention; and

FIGS. 7A, 7B, and 7C are exemplary views showing a process for manufacturing the frame of the speaker apparatus according to the embodiments.

### DESCRIPTION OF THE EMBODIMENTS

With reference to the drawings, embodiments of speaker apparatus and a frame for the speaker apparatus will be described below in detail.

### First Embodiment

A frame 1 for a speaker apparatus serves as an outer shell of the speaker apparatus. The frame 1 is formed by a resin molded product, and is formed like a cup-shape in order to accommodate a speaker functional portion including a vibrating plate 2 and a voice coil (not shown) on a center of a front surface of the frame. A flange portion 5 is formed on an outer periphery in connection to a front surface of the frame 1.

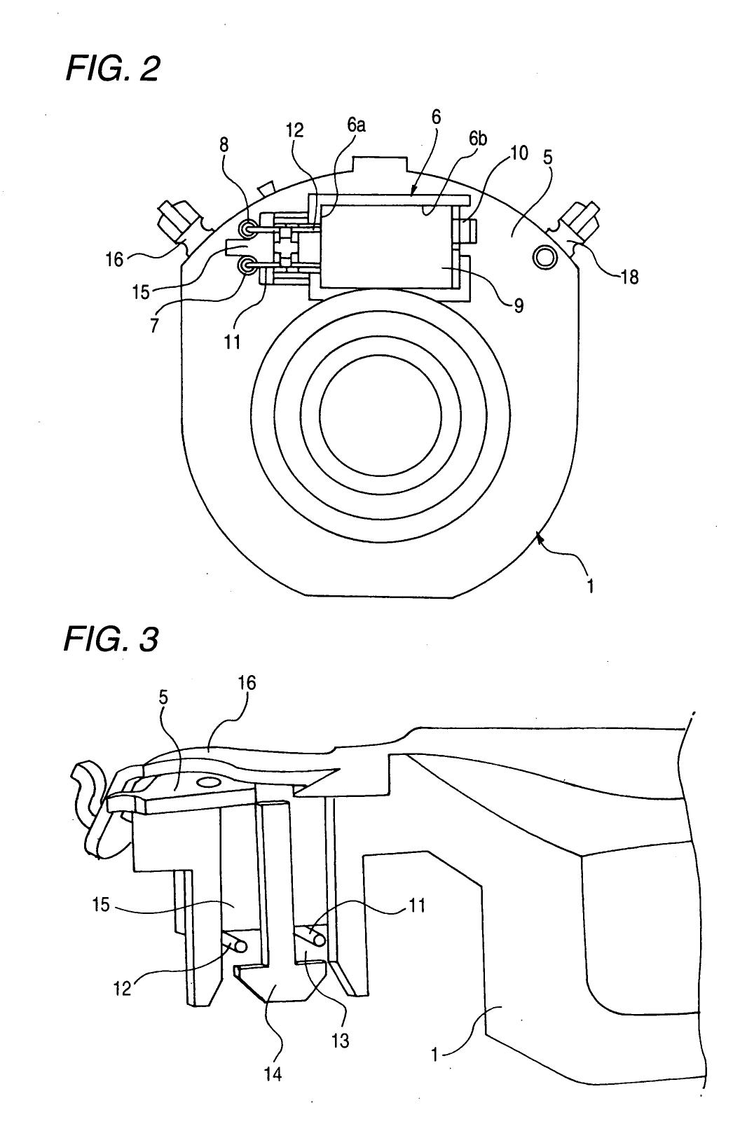

Referring to FIG. 2, a capacitor housing recessed portion 6 is formed on a back side of the flange portion 5 provided on the front surface. A pair of capacitor lead wire insertion holes 7 and 8 penetrating from a back face of the flange portion 5 to a front surface thereof are formed close to the capacitor housing recessed portion 6. The capacitor housing recessed portion 6 is formed, as a rectangular capacitor housing recessed portion. The capacitor housing recessed portion 6 has a width to come in pressure contact with the outer peripheral portion of a cylindrical capacitor 9 and a length to come in contact with both end faces of the capacitor 9 (a longitudinal direction of the capacitor). An elastic click member 10 for capacitor fixation, which serves to push the accommodated capacitor 9 against a wall surface 6a on a front end side (a lead wire pull-out side), is formed on either end in a direction of the length.

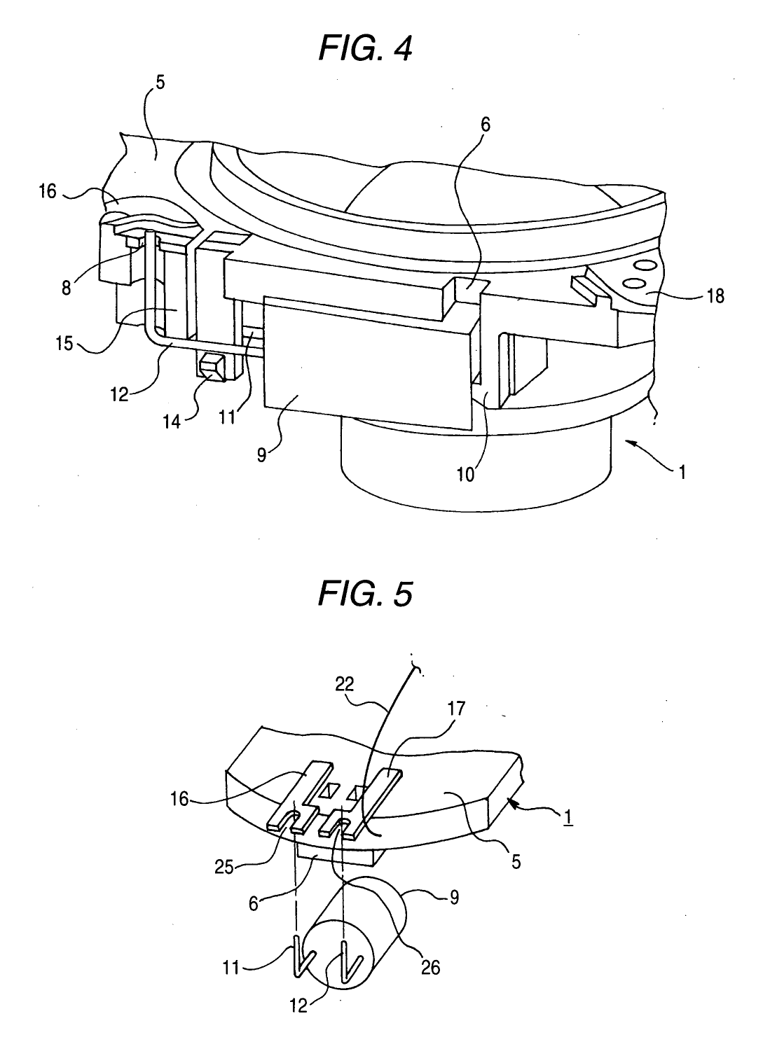

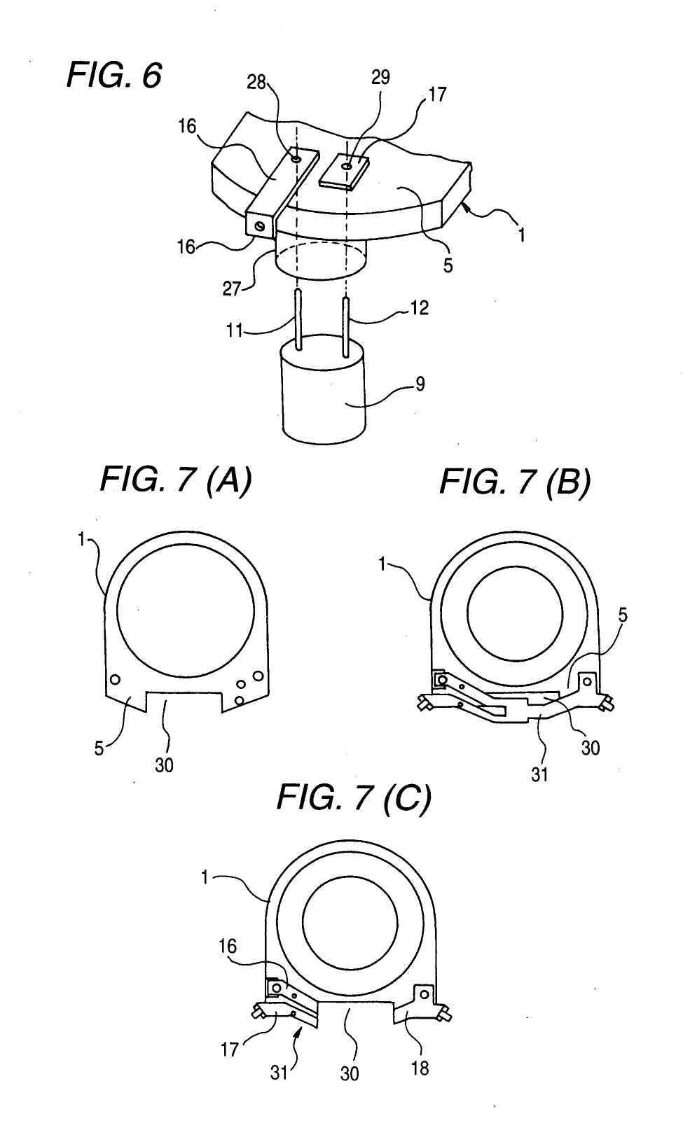

Referring to FIGS. 3 and 4, the capacitor 9 is pressed into the capacitor housing recessed portion 6 so as to be pushed in with a finger tip so that an outer peripheral portion thereof is constrained by a capacitor housing recessed portion wall surface 6b in a transverse direction. The outer peripheral portion is pushed against the front end side wall surface 6a of the capacitor housing recessed portion 6 by the elastic pressing force of the click member 10. The capacitor 9 is thus positioned and fixed into the capacitor housing recessed portion 6 so that the capacitor 9 in not movable.

According to the first embodiment, a pair of lead wires 11 and 12 of the capacitor 9 is previously bent to form an L-shape. Referring to FIG. 3, a groove portion 13 guides a straight part on the base portion side of the lead wires 11 and 12. The groove portion 13 is formed in the back part of the frame 1, and is adjacent to the wall surface 6a on a front end side of the capacitor housing recessed portion 6. A position regulating portion 14 has a T-shaped, and the position regulating portion 14 is formed in a central part of the groove portion 13. By the position regulating portion 14 and a separating wall 15, the positions of the lead wires 11 and 12 are regulated in a direction of a height, that is, a direction from the front surface of the frame 1 to the back face thereof.

When the capacitor 9 is accommodated in the capacitor housing recessed portion 6, tip portions of the L-shaped lead wires 11 and 12 are inserted into insertion holes 7 and 8 of the capacitor lead wires from the back side of the flange portion 5 so as to be slightly protruded toward the front side of the flange portion 5.

As shown in FIG. 2, the separating wall 15 is formed between the insertion holes 7 and 8 of the capacitor lead wires at the back side of the flange portion 5. By the position regulating portion 14 and the separating wall 15, a short circuit can be prevented from being caused by an unexpected contact of the lead wires 11 and 12.

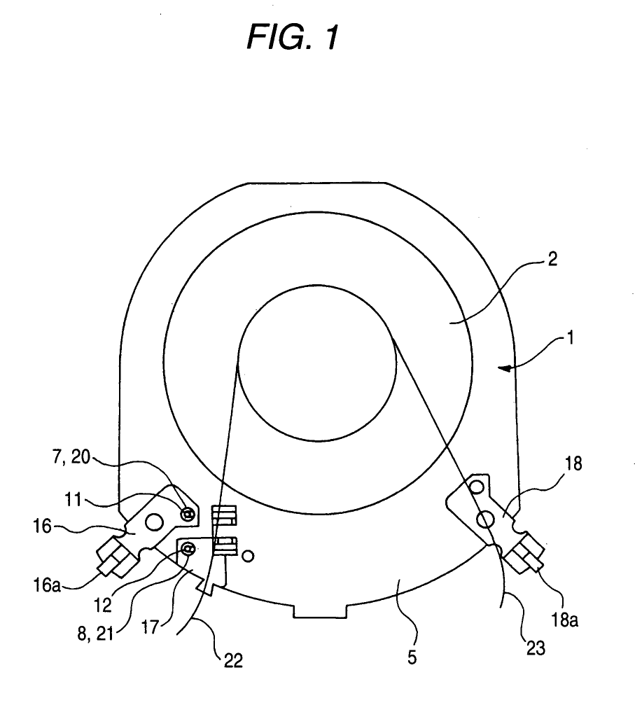

As shown in FIG. 1, plate-shaped terminal lugs 16 and 17 are fixed to the front surface of the flange portion 5 of the frame 1 in order to surround the insertion holes 7 and 8 of the capacitor lead wires. The terminal lug 16 corresponding to the insertion hole 7 of one of the capacitor lead wires and the terminal lug 17 corresponding to the insertion hole 8 of the other capacitor lead wire are separated from each other. The terminal lug 16 surrounding the insertion hole 7 has an external connecting end 16a overhung outward from the flange portion 5.

Separately from the two terminal lugs 16 and 17 covering the insertion holes 7 and 8 of the capacitor lead wires, a third terminal lug 18 is fixed to the front surface of the flange portion 5. The third terminal lug 18 is also provided with an external connecting end 18a overhung outward from the flange portion 5.

The terminal lugs 16 and 17 are provided with holes 20 and 21 for inserting the capacitor lead wires 11 and 12 in order to match the insertion holes 7 and 8 of the capacitor lead wires, respectively. The tips of the capacitor lead wires 11 and 12 are slightly protruded from the holes 20 and 21 of the terminal lug 16 and 17 toward the front side of the flange portion 5 through the insertion holes 7 and 8 of the capacitor lead wires in the flange portion 5.

The capacitor 9 is pressed into the capacitor housing recessed portion 6 on the back face of the frame 1, and the tips of the lead wires 11 and 12 are protruded toward the front surface of the frame 1 via the insertion holes 7 and 8 of the capacitor lead wires in the flange portion 5 and the holes 20 and 21 of the terminal lugs 16 and 17. A pair of voice coil lead wires 22 and 23 are pulled from a voice coil (not shown) toward the front surface of the frame 1, and the pair of voice coil lead wires 22, 23 are extended across upper surfaces of the terminal lug 17 where an external connecting end is not provided and the third terminal lug 18 from which the capacitor lead wire is not protruded, respectively. The voice coil lead wires 22 and 23 may be tied with outer end portions of the terminal lugs 17 and 18 corresponding thereto and also may be temporarily fixed, respectively.

The capacitor lead wires 11 and 12 and the terminal lugs 16 and 17 corresponding thereto are soldered in the hole positions of the the terminal lugs 16 and 17 at the front side of the frame 1. The voice coil lead wires 22 and 23 and the terminal lugs 17 and 18 corresponding thereto are soldered at the front side of the frame 1 respectively in the same manner. The voice coil lead wire 22 is connected to the capacitor lead wire 12 through the terminal lug 17. The capacitor lead wire 11 is conducted to the external connecting end 16a of the terminal lug 16 through the terminal lug 16. The voice coil lead wire 23 is conducted to the external connecting end 18a through the third terminal lug 18.

The capacitor 9 and the capacitor lead wires 11 and 12 are reliably fixed to the frame 1 by simply pressing the capacitor 9 into the capacitor housing recessed portion 6 on the back side of the frame 1. Therefore, it is possible to prevent a soldering defect of the terminal lugs 16 and 17 and the capacitor lead wires 11 and 12. Moreover, the capacitor 9 is disposed on the back side of the frame 1 for some reasons of a space. However, the capacitor lead wires 11 and 12 and the voice coil lead wires 22 and 23 can be soldered to the corresponding terminal lugs 16, 17 and 18 at the front side of the frame 1 together, and the capacitor lead wires 11 and 12 and the voice coil lead wires 22 and 23 can be processed in the same process. Consequently, quality of soldering can be enhanced, and furthermore, a cost can be reduced due to a decrease in soldering steps.

### Second Embodiment

End portions of a pair of terminal lugs 16 and 17 are protruded outward from a side part of a flange portion 5 of a frame 1, and lead wire inserting groove portions 25 and 26 for the lead wires 11 and 12 of a capacitor 9 are formed on which the terminal lugs 16, 17 are protruded. The capacitor 9 is pressed into a capacitor housing recessed portion on a back side of the frame 1 in the same manner of the first embodiment. The capacitor lead wires 11 and 12 are extended outward from the flange portion 5 of the frame 1, and L-shaped tip portions of the leas wires are directly inserted into the lead wire inserting groove portions 25 and 26 of the terminal lugs 16 and 17, and are thus subjected to a soldering processing. A voice coil lead wire 22 pulled to a front surface of the frame 1 is also soldered to the terminal lug 17 in the same manner.

The capacitor lead wires 11 and 12 and the voice coil lead wire 22 are soldered at the front side of the frame 1 in the same process. Insertion holes of the capacitor lead wires 11 and 12 are not formed on the frame 1. The capacitor lead wires 11 and 12 are directly inserted into the groove portions 25 and 26 of the terminal lugs 16 and 17. Therefore, the work can be carried out still more easily. The lead wire inserting groove portions 25 and 26 may have a configuration of through holes as in the first embodiment.

### Third Embodiment

Capacitor lead wires 11 and 12 are not L-shaped, and the capacitor lead wires 11, 12 are extended straight from an end of a capacitor 9. A cylindrical capacitor housing recessed portion 27 is formed perpendicularly to a flange portion 5 at a back side of the flange portion 5 of the frame 1. Plate-shaped terminal lugs 16 and 17 are fixed to a front surface of the flange portion 5 and insertion holes 28 and 29 for the capacitor lead wires are formed from the flange portion 5 to the terminal lugs 16 and 17 in the same manner as in the first embodiment. In a state in which the capacitor 9 is pressed into the cylindrical capacitor housing recessed portion 27 from the back side of the flange portion 5, the capacitor lead wires 11 and 12 are slightly protruded toward the front side of the terminal lugs 16 and 17 through the insertion holes 28 and 29 for the capacitor lead wires. In the same manner as in the first and second embodiments, accordingly, it is possible to carry out a soldering processing for the capacitor lead wires 11 and 12 and the terminal lugs 16 and 17, and a voice coil lead wire 22 and the terminal lug 17 on the front side of the frame 1 at the same time. Consequently, an L-shape processing for the lead wires 11 and 12 is not required. Thus, it is possible to reduce a cost by a decrease in the number of steps.

### Fourth Embodiment

In the frame for the speaker apparatus, a frame body portion formed by a resin and a terminal lug are formed integrally by insert molding. First of all, as shown in FIG. 7A, there is used a mold in which a rectangular capacitor housing recessed portion 30 is formed on a part of a flange portion 5 of a frame 1. As shown in FIG. 7B, an integral terminal lug 31 is disposed on a front surface of the flange portion 5 of the frame 1 across the capacitor housing recessed portion 30. In the embodiment, the terminal lug 31 has a configuration of a composite terminal taking such a shape that either end side is forked from a central part and the forked portions are positioned into the capacitor housing recessed portion. 30 of the frame 1, and the terminal lug 31 and the frame 1 are integrally subjected to insert molding in this state. FIG. 7B shows a state obtained after the insert molding.

As shown in FIG. 7C, the terminal lug 31 is cut transversely in a position of the capacitor housing recessed portion 30 in the frame 1. Consequently, a pair of branched terminal lugs 16 and 17 is fixed to one of sides of the front surface of the flange portion 5 in the frame 1 and one terminal lug 18 is fixed to the other side. The frame 1 for the speaker apparatus has three terminal lugs 16, 17 and 18 separated from each other.

As described in the above embodiments, the lead wires of the capacitor are inserted in the two terminal lugs 16 and 17 on either side and are fixed by soldering respectively, and furthermore, the voice coil lead wire is soldered to one of the two terminal lugs 16 and 17 (having the external connecting end) and the other voice coil lead wire is soldered to the terminal lug 18 on the opposite side which is divided. In any case, the soldering processing can be carried out in the same process at the front side of the frame 1. Thus, it is possible to reduce a cost by a decrease in steps.

Referring to the attachment of the terminal to the frame for the speaker apparatus of this type, conventionally, terminal lugs are molded as single products and are attached one by one to a frame formed by a resin through insert molding or are manually attached by a postprocessing. According to such a method, a processing cost is increased in the case in which the number of the terminals is increased, and it is hard to set a plurality of the terminal lugs into an insert mold or a workability for the postprocessing is deteriorated in the case in which a size of the terminal lug is reduced. In the invention, however, the terminal lug is integrated and set into the mold together with the frame formed by a resin. Therefore, stable setting can be obtained.

While there has been employed the configuration in which the rectangular capacitor housing recessed portion 30 is formed in the flange portion 5 of the frame 1 and the integral plate-shaped terminal lug 31 is provided across the capacitor housing recessed portion 30 in the seventh embodiment, the capacitor housing recessed portion 30 of the frame 1 may take a U shape, a V shape or a shape of a through hole and the plate-shaped terminal lug 31 may be provided thereacross. Moreover, it is also possible to employ a configuration in which the capacitor housing recessed portion 30 is not formed on the frame 1 but only the terminal lug is partially protruded outward from the frame 1 and this portion is cut to form a plurality of terminal lugs after insert molding.

While the cut portion of the terminal lug is exposed toward the frame in the fourth embodiment, furthermore, the cut portion of the terminal lug may be covered with such a thin resin that the cutting is not influenced. Moreover, it is also possible to use an integral terminal lug which considers the easiness of press molding of the terminal lug and the readiness of cutting after a postprocessing depending on a shape of a terminal lug which is required.

As described above in detail, the speaker apparatus according to the first embodiment has such a structure that there are provided the frame 1 for the speaker apparatus, the terminal lugs 16, 17 and 18 attached to the flange portion 5 disposed on the front surface of the frame 1, and the capacitor 9 accommodated in the capacitor housing recessed portion 6 disposed on the back face of the frame 1 and protruded toward the front surface of the frame 1 in such a manner that the capacitor lead wires 11 and 12 penetrate through the terminal lugs 16 and 17, and the voice coil lead wires 22 and 23 and the capacitor lead wires 11 and 12 are connected to the terminal lugs 16, 17 and 18 on the front surface of the frame 1 for the speaker apparatus.

By the structure, it is possible to reliably fix the capacitor 9 for characteristic regulation by simply pressing the capacitor 9 into the capacitor housing recessed portion 6 on the back face of the frame. Moreover, the capacitor lead wires 11 and 12 are protruded toward the front surface of the frame 1. Therefore, the voice coil lead wires 22 and 23 can be soldered, and at the same time, the capacitor lead wires 11 and 12 can be soldered to the terminal lugs 16, 17 and 18 fixed to the front surface of the frame at the front side of the frame. Thus, it is possible to provide a speaker apparatus in which a workability can be enhanced and high quality of the soldering processing can be obtained.

According to the method of manufacturing the speaker apparatus in accordance with the first to third embodiments, moreover, the terminal lugs 16, 17 and 18 are fixed to be exposed to the flange portion 5 provided on the front surface of the frame 1 and the lead wires 11 and 12 of the capacitor 9 provided in the back portion of the frame 1 are protruded toward the front surface of the frame 1 through the terminal lugs 16 and 17, and the capacitor lead wires 11 and 12 and the voice coil lead wires 22 and 23 are connected to the front surface of the frame 1 through the terminal lugs 16, 17 and 18.

By the structure, the capacitor 9 can be attached very easily, and furthermore, the terminal connection of the capacitor lead wires 11 and 12 and the voice coil lead wires 22 and 23 can be carried out in the same process at the front side of the speaker apparatus, and a reduction in a manufacturing cost can be achieved by a decrease in the manufacturing steps and an improvement in a workability.

Moreover, the frame for the speaker apparatus according to the embodiment has such a structure that the flange portion 5 is formed in connection to the front surface of the frame, the capacitor housing recessed portion 6 is formed in the back portion, the terminal lugs 16, 17 and 18 are fixed to the front surface of the flange portion 5, and the insertion holes 7 and 8 for the capacitor lead wires 11 and 12 are formed in the flange portion 5 in penetration through the terminal lugs 16 and 17.

By the structure, the lead wires 11 and 12 of the capacitor 9 pressed into the capacitor housing recessed portion 6 provided on the back face of the frame are protruded toward the front surface of the frame 1. Therefore, the voice coil lead wires 22 and 23 can be soldered, and at the same time, the capacitor lead wires 11 and 12 can be soldered to the terminal lugs 16, 17 and 18 fixed to the front surface of the frame at the front side of the frame. Thus, it is possible to provide the frame 1 for the speaker apparatus in which a workability can be enhanced and high quality of the soldering processing can be obtained.

What is claimed is:

1. A speaker apparatus comprising:
a frame having a flange portion on a front surface thereof and a recessed portion on a back face thereof;
a terminal lug attached to the flange portion of the frame;
a capacitor accommodated in the recessed portion of the frame, the capacitor having a capacitor lead wire connected to the terminal lug at the front surface of the frame, and
a voice coil connected to the terminal lug at the front surface of the frame.

2. A method of manufacturing a speaker apparatus comprising:
fixing a terminal lug to be exposed to a flange portion provided on a front surface of a frame;
causing a capacitor lead wire of a capacitor accommodated in a back portion of the frame to penetrate through the terminal lug and protruding the capacitor lead wire toward a front surface of the frame; and
connecting the capacitor lead wire to a voice coil lead wire via the terminal lug at the front surface of the frame.

3. The method of manufacturing a speaker apparatus according to claim 2, comprising:
integrating the terminal lug so as to form a plate-shape;
insert-molding the integrated terminal lug into the flange portion; and
dividing a part of the terminal lug into a plurality of pieces.

4. A frame for a speaker apparatus comprising:
a flange portion connected to a front surface of the frame;
a capacitor housing recessed portion formed in a back portion;
a terminal lug fixed to a front surface of the flange portion; and
an insertion hole for a capacitor lead wire formed in the flange portion to penetrate via the terminal lug.

5. The frame for a speaker apparatus according to claim 4, wherein a position regulating guide portion for the capacitor lead wire is adjacent to the capacitor housing recessed portion.
